(19) United States
(12) Patent Application Publication
(10) Pub. No.: US 2015/0002599 A1
(43) Pub. Date: Jan. 1, 2015

(54) IMAGE FORMING APPARATUS

(71) Applicant: CANON KABUSHIKI KAISHA, Tokyo (JP)

(72) Inventor: Shunsaku Kondo, Toride-shi (JP)

(21) Appl. No.: 14/298,556

(22) Filed: Jun. 6, 2014

(30) Foreign Application Priority Data
Jun. 28, 2013 (JP) 2013-137469
May 7, 2014 (JP) 2014-096226

(51) Int. Cl. B41J 2/45; G03G 15/04

(52) U.S. Cl. CPC B41J 2/451; G03G 15/04036
USPC 347/134

(57) ABSTRACT

An image forming apparatus according to an aspect of the present invention uses a BD sensor to measure a time interval between light beams emitted from two light emitting elements in a period during which constant speed control for maintaining the rotation speed of a polygon mirror at a target speed is performed and speed change control for accelerating or decelerating the rotation speed toward the target speed is not performed. Based on the time interval between BD signals generated according to the two light beams that are incident on the BD sensor while the constant speed control is being executed, the image forming apparatus controls the emission timings of the light beams that are based on the image data for the light emitting elements.

### BACKGROUND OF THE INVENTION

1. Field of the Invention

The present invention relates to an electrophotographic image forming apparatus.

2. Description of the Related Art

Image forming apparatuses are known which form electrostatic latent images on a photosensitive member by deflecting a light beam emitted from a light source using a rotating polygonal mirror and scanning the photosensitive member using the deflected light beam. This kind of image forming apparatus includes an optical sensor for detecting the light beam deflected by the rotating polygonal mirror (beam detection (BD) sensor), and the optical sensor generates a synchronization signal upon detecting the light beam. By causing the light beam to be emitted from the light source at a timing that is determined using the synchronization signal generated by the optical sensor as a reference, the image forming apparatus keeps constant the writing start position for the electrostatic latent image (image) in the direction in which the light beam scans the photosensitive member (scanning direction).

Also, image forming apparatuses are known which include multiple light emitting elements as light sources for emitting light beams that each scan different lines on the photosensitive member in parallel in order to realize a higher image formation speed and higher resolution images. With this kind of image forming apparatus, a higher image formation speed is realized by scanning multiple lines using multiple light beams at the same time, and higher resolution images are realized by adjusting the interval between the lines in the sub-scanning direction.

FIG. 7A shows an example of a light source included in this kind of image forming apparatus, and in this light source, multiple light emitting elements (LD₁ to LD_{N}) are arranged in a row on a plane including an X axis and a Y axis (XY plane). Note that the X axis direction corresponds to the main scanning direction, and the Y axis direction corresponds to the rotation direction of the photosensitive member (sub-scanning direction). With this kind of image forming apparatus, the interval between the light emitting elements in the Y axis direction is adjusted by rotating the light source in the direction of the arrow on the XY plane in the assembly step at the factory, as shown in FIG. 7A. According to this, the interval in the sub-scanning direction of the scanning lines on the photosensitive member (exposure position interval), which are created by the light beams emitted from the light emitting elements, can be adjusted such that it corresponds to a predetermined resolution.

When the light source is rotated in the direction of the arrows shown in FIG. 7A, the interval between the light emitting elements in the Y axis direction changes, and the interval between the light emitting elements in the X direction changes as well. According to this, the light beams emitted from the light emitting elements each form an image on the photosensitive member at different positions S₁ to S_{N} in the main scanning direction, as shown in FIG. 7B. Because of this, with an image forming apparatus including a light source such as that shown in FIG. 7A, the writing start positions in the main scanning direction for the electrostatic latent images formed by the light beams emitted from the light emitting elements need to coincide with each other. For this reason, the image forming apparatus causes a light beam to be emitted from a specific light emitting element, an optical sensor detects the light beam and generates a synchronization signal, and the image forming apparatus uses the synchronization signal as a reference to determine the light beam emission timing for each light emitting element such that the writing start positions for the electrostatic latent images coincide with each other. Furthermore, the image forming apparatus causes the light beams to be emitted from the light emitting elements at emission timings determined for respective light emitting elements.

In the above-mentioned assembly step, the light source rotation angle by which the resolution of the image is adjusted to a predetermined resolution varies depending on the installation state of the light source in the image forming apparatus and optical characteristics of optical members such as lenses and mirrors. For this reason, the adjustment amount for the light source rotation angle sometimes varies for each image forming apparatus. In other words, the interval between the light emitting elements in the X axis direction in the light source after rotation adjustment is not always the same for different image forming apparatuses. Here, if the light beam emission timing for each light emitting element, which is obtained by using as a reference the synchronization signals generated by the optical sensor, is set to the same timing for all image forming apparatuses, there is a possibility that a shift in the writing start positions in the main scanning direction for the electrostatic latent images will occur between light emitting elements.

Japanese Patent Laid-Open No. 2008-89695 discloses a technique for suppressing shifts in the writing start positions in the main scanning direction for the electrostatic latent image that are generated due to light source attachment errors in the assembly step as described above. The image forming apparatus disclosed in this patent literature uses an optical sensor (BD sensor) to detect light beams emitted from a first light emitting element and a second light emitting element and generates multiple horizontal synchronization signals. Furthermore, the image forming apparatus sets a light beam emission timing for the second light emitting element relative to the light beam emission timing for the first light emitting element based on the difference in the generation times of the generated horizontal synchronization signals. This compensates for the light source attachment error in the assembly step and suppresses shifts in the writing start positions for the electrostatic latent images between the light emitting elements.

The following problem is present in the method for measuring the time interval of light beam detection (i.e., beam interval) by the BD sensor as described above. For example, when printing images on both sides of a recording medium with the image forming apparatus, there are cases where the rotation speed of the polygon mirror (i.e., the light beam scanning speed) changes between the case of executing printing on the front side (first side) and the case of executing printing on the back side (second side). In such a case, if the above-mentioned measurement is executed while the light beam scanning speed is accelerating or decelerating, there is a possibility that the measurement accuracy will decrease due to the change in the scanning speed. Similarly, there are cases in which the rotation speed of the polygon mirror changes between the case of forming an image on regular paper and the case of forming an image on thick paper whose grammage is greater than that of regular paper. In this case as well, if the above-mentioned measurement is executed while the light beam scanning speed is accelerating or decelerating, there is a possibility that the measurement accuracy will decrease due to the change in the scanning speed.

### SUMMARY OF THE INVENTION

The present invention has been made in view of the above-mentioned problem. The present invention in one aspect provides a technique of, in an image forming apparatus including multiple light emitting elements, suppressing the occurrence of measurement errors due to changes in light beam scanning speed when measuring the interval between light beams emitted from two light emitting elements.

According to an aspect of the present invention, there is provided an image forming apparatus that uses toner to develop an electrostatic latent image that is formed on a photosensitive member by exposing the photosensitive member using a plurality of light beams, and forms an image on a recording medium by transferring a toner image developed on the photosensitive member onto the recording medium, the image forming apparatus comprising: a light source including a plurality of light emitting elements that each emit a light beam so as to form an electrostatic latent image on the photosensitive member; a rotating polygonal mirror configured to deflect the plurality of light beams emitted from the plurality of light emitting elements such that the plurality of light beams scan the photosensitive member; a detection unit provided on a scanning path of the plurality of light beams deflected by the rotating polygonal mirror, for outputting a detection signal indicating that a light beam has been detected due to the light beam deflected by the rotating polygonal mirror being incident on the detection unit; a speed control unit configured to execute speed change control for accelerating or decelerating a rotation speed of the rotating polygonal mirror toward a target speed, and constant speed control for maintaining the rotation speed at the target speed, the target speed including at least a first rotation speed and a second rotation speed that is different from the first rotation speed, and the first and second rotation speeds being rotation speeds of the rotating polygonal mirror when forming an electrostatic latent image for forming a toner image that is to be transferred onto a recording medium; a measuring unit configured to control the light source such that first and second light beams from first and second light emitting elements among the plurality of light emitting elements are sequentially incident on the detection unit, and to measure a time interval between detection signals generated according to the first and second light beams that are incident on the detection unit in a period of executing the constant speed control for maintaining the rotation speed at the second rotation speed, the period being before or after a period in which the speed change control for changing from the first rotation speed to the second rotation speed is performed by the speed control unit after an electrostatic latent image that corresponds to one recording medium has been formed and being before an electrostatic latent image that corresponds to a recording medium subsequent to the one recording medium is formed; and a control unit configured to, based on the time interval between the detection signals generated according to the first and second light beams that are incident on the detection unit in the period in which the constant speed control is being executed by the speed control unit, control relative emission timings, for the plurality of light emitting elements, of light beams that are based on image data.

According to the present invention, it is possible to provide a technique of, in an image forming apparatus including multiple light emitting elements, suppressing the occurrence of measurement errors due to changes in light beam scanning speed when measuring the interval between light beams emitted from two light emitting elements.

Further features of the present invention will become apparent from the following description of embodiments with reference to the attached drawings.

### BRIEF DESCRIPTION OF THE DRAWINGS

FIG. 1 is a schematic cross-section diagram of an image forming apparatus according to an embodiment of the present invention.

FIG. 2A is a diagram showing a configuration of an optical scanning apparatus 104 that scans a photosensitive drum using a light beam according to the embodiment of the present invention.

FIG. 2B is a diagram showing a modified example of the configuration of the optical scanning apparatus 104 that scans the surface of a photosensitive drum using a light beam according to the embodiment of the present invention.

FIGS. 3A to 3C are diagrams showing schematic configurations of light sources and BD sensors and scanning positions on a photosensitive drum and a BD sensor for laser beams emitted from the light source according to the embodiment of the present invention.

FIG. 4 is a block diagram showing a control configuration of the image forming apparatus according to the embodiment of the present invention.

FIG. 5 is a timing chart showing the timing of operations of the optical scanning apparatus according to the embodiment of the present invention.

FIG. 6A is a flowchart showing a procedure of image formation processing executed by the image forming apparatus according to the embodiment of the present invention.

FIG. 6B is a flowchart showing a procedure for laser emission timing control executed in step S604 (FIG. 6A) and step S1005 (FIG. 10).

FIGS. 7A to 7C are diagrams showing an example of a light source configuration and a modified example of scanning positions for laser beams emitted from the light source on a photosensitive drum.

FIG. 8 is a diagram showing an example of a relationship between rotation speed of a polygon mirror in the optical scanning apparatus and time intervals between two BD signals output from a BD sensor.

FIGS. 9A to 9D are diagrams showing examples of execution timing for beam interval measurement in the image forming apparatus according to the embodiment of the present invention.

FIG. 10 is a flowchart showing a procedure of image formation processing executed by the image forming apparatus according to a modified example of the embodiment of the present invention.

### DESCRIPTION OF THE EMBODIMENTS

Hereinafter, embodiments of the present invention will be described in detail with reference to the accompanying drawings. It should be noted that the following embodiments are not intended to limit the scope of the appended claims, and that not all the combinations of features described in the embodiments are necessarily essential to the solving means of the present invention.

The following describes an embodiment in which the present invention has been applied to an image forming apparatus that forms multi-color (full color) images using toner (developing material) of multiple colors. Note that the present invention can be applied to an image forming apparatus that forms monochrome images using only a single color of toner (e.g., black).

Hardware Configuration of Image Forming Apparatus

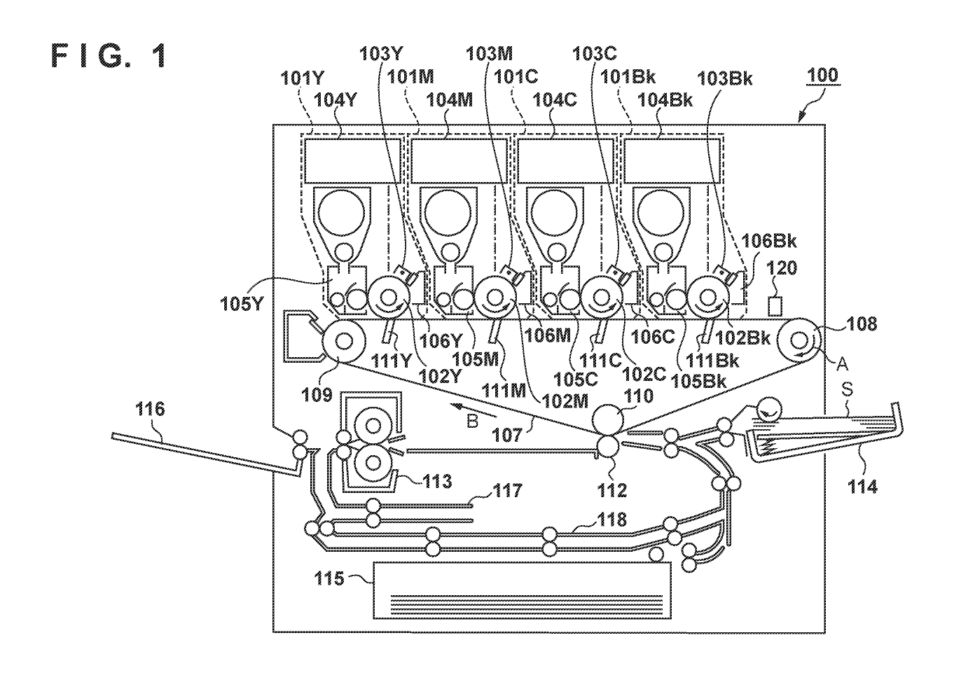

First, a configuration of an image forming apparatus 100 according to the present embodiment will be described with reference to FIG. 1. The image forming apparatus 100 includes four image forming units 101Y, 101M, 101C, and 101Bk that form images (toner images) using yellow (Y), magenta (M), cyan (C), and black (Bk) toner respectively.

The image forming units 101Y, 101M, 101C, and 101Bk include photosensitive drums (photosensitive members) 102Y, 102M, 102C, and 102Bk respectively. Charging units 103Y, 103M, 103C, and 103Bk, optical scanning apparatuses 104Y, 104M, 104C, and 104Bk, and developing units 105Y, 105M, 105C, and 105Bk are arranged in the vicinity of the photosensitive drums 102Y, 102M, 102C, and 102Bk respectively. Drum cleaning units 106Y, 106M, 106C, and 106Bk are furthermore arranged in the vicinity of the photosensitive drums 102Y, 102M, 102C, and 102Bk respectively.

An intermediate transfer belt (intermediate transfer member) 107 in the shape of an endless belt is arranged below the photosensitive drums 102Y, 102M, 102C, and 102Bk. The intermediate transfer belt 107 is wound around a driving roller 108 and driven rollers 109 and 110. When image formation is in progress, the peripheral surface of the intermediate transfer belt 107 moves in the direction of arrow B in accordance with the rotation of the driving roller 108 in the direction of arrow A shown in FIG. 1. Primary transfer units 111Y, 111M, 111C, and 111Bk are arranged at positions opposing the photosensitive drums 102Y, 102M, 102C, and 102Bk via the intermediate transfer belt 107. The image forming apparatus 100 further includes a secondary transfer unit 112 for transferring a toner image formed on the intermediate transfer belt 107 onto a recording medium S, and a fixing unit 113 for fixing, to the recording medium S, toner image that has been transferred onto the recording medium S.

Image forming processes from a charging process to a developing process in the image forming apparatus 100 having the above-described configuration will be described next. Note that the image forming processes executed by the respective image forming units 101Y, 101M, 101C, and 101Bk are similar. For this reason, a description will be given below using the image forming process in the image forming unit 101Y as an example, and the image forming processes in the image forming units 101M, 101C, and 101Bk will not be described.

First, the charging unit 103Y in the image forming unit 101Y charges the photosensitive drum 102Y (the surface thereof) that is being driven so as to rotate. The optical scanning apparatus 104Y emits multiple laser beams (light beams), scans the charged photosensitive drum 102Y (the surface thereof) using the laser beams, and thereby exposes the photosensitive drum 102Y (the surface thereof) by using the laser beams. According to this, an electrostatic latent image is formed on the rotating photosensitive drum 102Y. After being formed on the photosensitive drum 102Y, the electrostatic latent image is developed by the developing unit 105Y using Y toner. As a result, a Y toner image is formed on the photosensitive drum 102Y. Also, in the image forming units 101M, 101C, and 101Bk, M, C, and Bk toner images are formed on the photosensitive drums 102M, 102C, and 102Bk respectively with processes similar to that of the image forming unit 101Y.

The image forming processes from a transfer process onward will be described below. In the transfer process, first, the primary transfer units 111Y, 111M, 111C, and 111Bk each apply a transfer bias to the intermediate transfer belt 107. According to this, toner images of four colors (Y, M, C, and Bk) that have been formed on the photosensitive drums 102Y, 102M, 102C, and 102Bk are transferred in an overlaid manner onto the intermediate transfer belt 107.

After being formed on the intermediate transfer belt 107 in an overlaid manner, the toner image composed of four colors of toner is conveyed to a secondary nip portion between the secondary transfer unit 112 and the intermediate transfer belt 107 in accordance with the movement of the peripheral surface of the intermediate transfer belt 107. The recording medium S is conveyed from a manual feeding cassette 114 or a paper feeding cassette 115 to the secondary transfer nip portion in synchronization with the timing at which the toner image formed on the intermediate transfer belt 107 is conveyed to the secondary transfer nip portion. In the secondary transfer nip portion, the toner image formed on the intermediate transfer belt 107 is transferred onto the recording medium S by means of a transfer bias applied by the secondary transfer unit 112 (secondary transfer).

After being formed on the recording medium S, the toner image undergoes heating in the fixing unit 113 and is thereby fixed to the recording medium S. After a multi-color (full color) image is formed in this way on the recording medium S, the recording medium S is discharged to an discharge unit 116.

Note that in the case of executing double-sided printing by which images are formed on both sides of the recording medium S, image formation on the front side (first side) of the recording medium S is performed first, and then image formation on the back side (second side) is performed. In this case, after the image formation on the first side ends and the recording medium S has passed through the fixing unit 113, the recording medium S is guided to a reversal path 117 by means of a switching operation performed by a flapper (not shown) provided on the conveyance path. Subsequently, the conveyance direction of the recording medium S is switched to the opposite direction, the recording medium S is conveyed from the reversal path 117 to a double-sided conveyance path 118, and is once again conveyed to the secondary transfer nip portion. Subsequently, an image is formed on the second side of the recording medium S in a manner similar to the image formation on the first side, and the recording medium S is discharged to the discharge unit 116.

Note that after the transfer of the toner image onto the intermediate transfer belt 107 ends, toner remaining on the photosensitive drums 102Y, 102M, 102C, and 102Bk is removed by the drum cleaning units 106Y, 106M, 106C, and 106Bk respectively. When the series of image forming processes ends in this way, image forming processes for the next recording medium S are subsequently started.

The image forming apparatus 100 performs a density adjustment operation to keep constant the density characteristic of the image to be formed. A density detection sensor 120 for detecting the density of a toner image formed on the intermediate transfer belt 107 is provided at a position opposing the intermediate transfer belt 107. The image forming apparatus 100 performs a predetermined density adjustment operation using the density detection sensor 120 to detect the densities of the toner images of respective colors formed on the intermediate transfer belt 107. The optical scanning apparatuses 104Y, 104M, 104C, and 104Bk can adjust the density characteristic of the image to be formed, by adjusting the light power of the light beams emitted from the light source such that the densities of the toner images of respective colors detected by the density detection sensor 120 become a predetermined value. Note that the adjustment of the light power of the light beam for this kind of density characteristic adjustment can be realized by adjusting a light power target value (target light power) used in a later-described automatic power control (APC) for example.

Hardware Configuration of Optical Scanning Apparatus

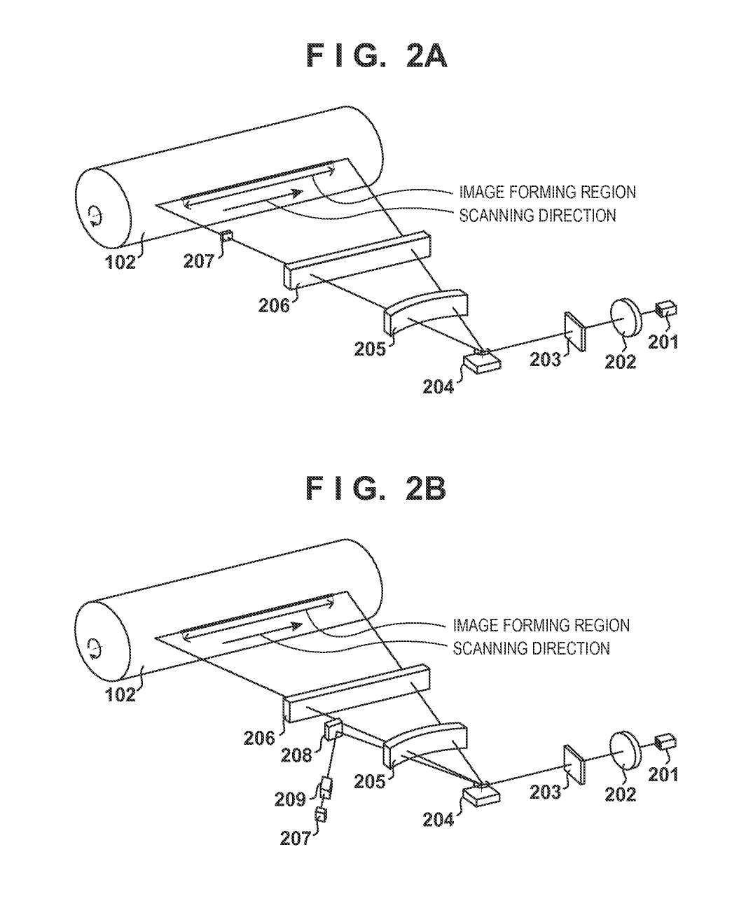

The configuration of the optical scanning apparatuses 104Y, 104M, 104C, and 104Bk will be described next with reference to FIGS. 2A, 3A to 3C, and 7A to 7C. Note that since the configurations of the image forming units 101Y, 101M, 101C, and 101Bk are the same, there are cases below where reference numerals are used without the suffixes Y, M, C, and Bk. For example, “photosensitive drum 102” represents the photosensitive drums 102Y, 102M, 102C, and 102Bk, and “optical scanning apparatus 104” represents the optical scanning apparatuses 104Y, 104M, 104C, and 104Bk.

FIG. 2A is a diagram showing the configuration of the optical scanning apparatus 104. The optical scanning apparatus 104 includes a laser light source 201 and various optical members 202 to 206 (a collimator lens 202, a cylindrical lens 203, a polygon mirror (rotating polygonal mirror) 204, and fθ lenses 205 and 206). The laser light source (referred to hereinafter as simply “light source”) 201 generates and outputs (emits) a laser beam (light beam) with a light power that corresponds to the driving current. The collimator lens 202 shapes the laser beam emitted from the light source 201 into collimated light. After the laser beam passes through the collimator lens 202, the cylindrical lens 203 condenses the laser beam in the sub-scanning direction (direction corresponding to the rotation direction of the photosensitive drum 102).

After passing through the cylindrical lens 203, the laser beam is incident on one of the reflecting surfaces of the polygon mirror 204. The polygon mirror 204 reflects the incident laser beam with the reflecting surfaces while rotating such that the incident laser beam is deflected at continuous angles. The laser beam deflected by the polygon mirror 204 is sequentially incident on the fθ lenses 205 and 206. Due to passing through the fθ lenses (scanning lenses) 205 and 206, the laser beam becomes a scanning beam that scans the photosensitive drum 102 at a constant speed.

On the scanning path of the laser beam deflected by the polygon mirror 204, the optical scanning apparatus 104 further includes a beam detection (BD) sensor 207 as an optical sensor for detecting laser beams. That is to say, the BD sensor 207 is provided on the scanning path for when multiple laser beams (light beams) scan the photosensitive drum 102. When a laser beam deflected by the polygon mirror 204 is incident on the BD sensor 207, the BD sensor 207 outputs, as a synchronization signal (horizontal synchronization signal), a detection signal (BD signal) indicating that the laser beam has been detected. As will be described later, the synchronization signals output from the BD sensor 207 are used as a reference to control the turning-on timings of the light emitting elements (LD₁ to LD_{N}) based on the image data.

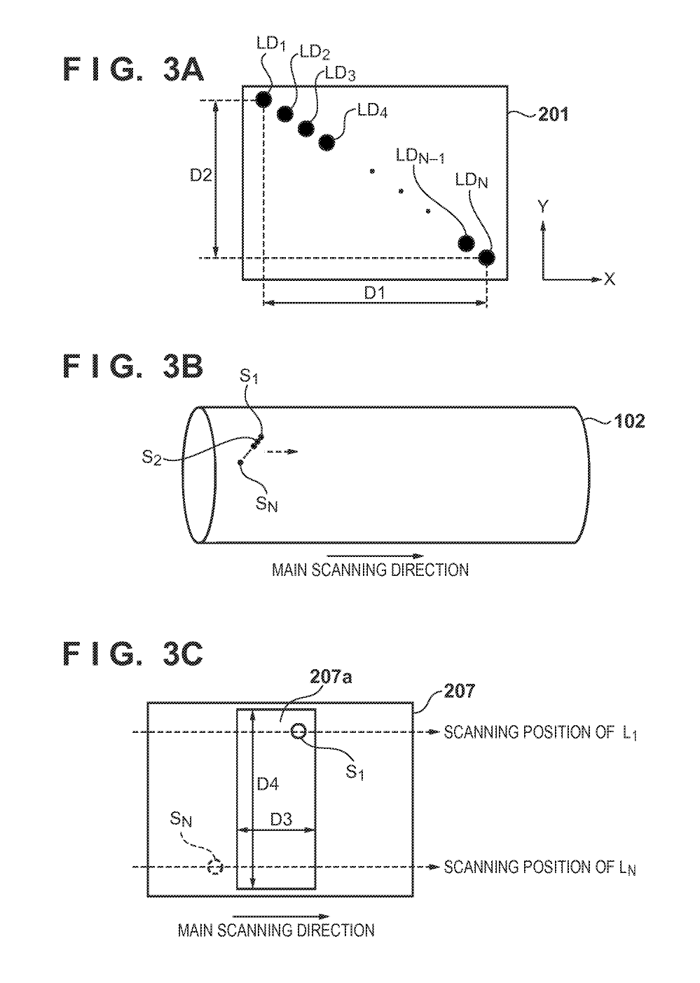

Next, the configuration of the light source 201 and the scanning positions of the laser beams emitted from the light source 201 on the photosensitive drum 102 and the BD sensor 207 will be described with reference to FIGS. 3A to 3C.

First, FIG. 3A is an enlarged view of the light source 201, and FIG. 3B is a diagram showing the scanning positions of the laser beams emitted from the light source 201 on the photosensitive drum 102. The light source 201 includes N light emitting elements (LD₁ to LD_{N}) that each emit (output) a laser beam. The n-th (n being an integer from 1 to N) light emitting element n (LDₙ) of the light source 201 emits a laser beam Lₙ. The X axis direction in FIG. 3A is the direction that corresponds to the direction in which the laser beams deflected by the polygon mirror 204 scan the photosensitive drum 102 (the main scanning direction). Also, the Y axis direction is the direction orthogonal to the main scanning direction, which is the direction that corresponds to the rotation direction of the photosensitive drum 102 (sub-scanning direction).

As shown in FIG. 3B, the laser beams L₁ to L_{N} that have been emitted from the light emitting elements 1 to N form spot-shaped images at positions S₁ to S_{N} that are different in the sub-scanning direction on the photosensitive drum 102. According to this, the laser beams L₁ to L_{N} scan main scanning lines that are adjacent in the sub-scanning direction in parallel on the photosensitive drum 102. Also, due to the light emitting elements 1 to N being arranged in an array as shown in FIG. 3A in the light source 201, the laser beams L₁ to L_{N} form images at positions on the photosensitive drum 102 that are different in the main scanning direction as well, as shown in FIG. 3B. Note that in FIG. 3A, the N light emitting elements (LD₁ to LD_{N}) are arranged in one straight line (one-dimensionally) in the light source 201, but they may be arranged two-dimensionally.

Reference numeral D1 in FIG. 3A represents the interval (distance) between the light emitting element 1 (LD₁) and the light emitting element N (LD_{N}) in the X axis direction. In the present embodiment, the light emitting elements 1 and N are light emitting elements arranged at the two ends of the light emitting elements that are arranged in a straight line in the light source 201. The light emitting element N is arranged the farthest from the light emitting element 1 in the X axis direction. For this reason, as shown in FIG. 3B, among the laser beams, the image forming position S_{N} of the laser beam L_{N} is at the position that is the farthest from the image forming position S₁ of the laser beam L₁ in the main scanning direction on the photosensitive drum 102.

Reference numeral D2 in FIG. 3A represents the interval (distance) between the light emitting element 1 (LD₁) and the light emitting element N (LD_{N}) in the Y axis direction. Among the light emitting elements, the light emitting element N is the farthest from the light emitting element 1 in the Y axis direction. For this reason, as shown in FIG. 3B, among the laser beams, the image forming position S_{N} of the laser beam L_{N} is at the position that is the farthest from the image forming position S₁ of the laser beam L₁ in the sub-scanning direction on the photosensitive drum 102.

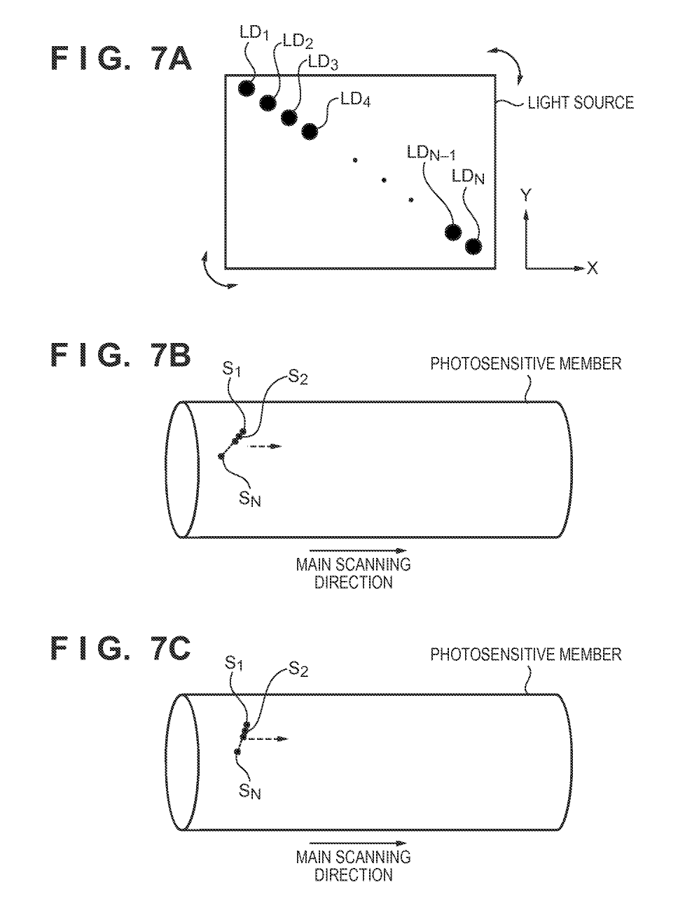

A light emitting element interval Ps=D2/N−1 in the Y axis direction (sub-scanning direction) is an interval that corresponds to the resolution of the image that is to be formed by the image forming apparatus 100. Ps is a value that is set by performing rotation adjustment on the light source 201 (as shown in FIG. 7A) in the assembly step of the image forming apparatus 100 such that the interval between adjacent image forming positions Sₙ in the sub-scanning direction on the photosensitive drum 102 becomes an interval that corresponds to a predetermined resolution. Also, a light emitting element interval Pm=D1/N−1 in the X axis direction (main scanning direction) is a value that is determined uniquely depending on the light emitting element interval Ps in the Y axis direction.

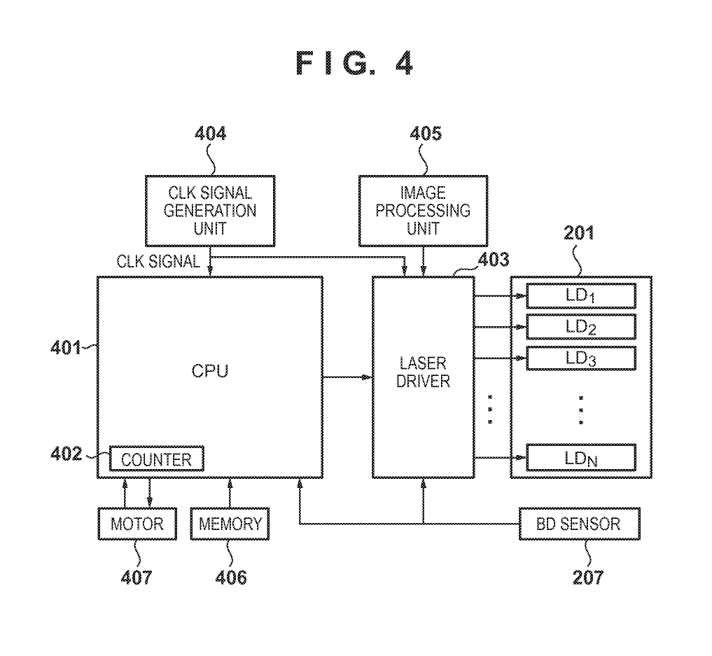

The timings according to which the laser beams are to be emitted from the light emitting elements (LDₙ), and which are determined using the timing of the generation and output of the synchronization signals (BD signals) by the BD sensor 207 as a reference, are set for each light emitting element using a predetermined jig in the assembly step. The set timings for the respective light emitting elements are stored in a memory 406 (FIG. 4) as initial values at the time of factory shipping of the image forming apparatus 100. The initial values for the timings according to which the laser beams are to be emitted from the light emitting elements (LDₙ) set in this way have values corresponding to Pm.

Next, FIG. 3C is a diagram showing a schematic configuration of the BD sensor 207 and the scanning positions of the laser beams emitted from the light source 201 on the BD sensor 207. The BD sensor 207 includes a light-receiving surface 207a on which photoelectric conversion elements are arranged planarly. When a laser beam is incident on the light-receiving surface 207a, the BD sensor 207 generates and outputs a BD signal (synchronization signal) indicating that a laser beam has been detected. The optical scanning apparatus 104 of the present embodiment causes laser beams L₁ and L_{N} that have been emitted from the light emitting elements 1 and N (LD₁ and LD_{N}) to be incident on the BD sensor 207 in order, and thus causes (two) BD signals corresponding to the laser beams to be output in order from the BD sensor 207. Note that in the present embodiment, the light emitting elements 1 and N (LD₁ and LD_{N}) are examples of a first light emitting element and a second light emitting element respectively, and the laser beams L₁ and L_{N} are examples of a first light beam and a second light beam respectively.

In FIG. 3C, the width in the main scanning direction and the width in the direction corresponding to the sub-scanning direction of the light-receiving surface 207a are indicated as D3 and D4 respectively. In the present embodiment, the laser beams L₁ and L_{N} that are emitted from the light emitting elements 1 and N (LD₁ and LD_{N}) respectively scan the light-receiving surface 207a of the BD sensor 207 as shown in FIG. 3C. For this reason, the width D4 is set to a value that satisfies the condition D4>D2×α, such that both of the laser beams L₁ and L_{N} can be incident on the light-receiving surface 207a. Note that a is the rate of fluctuation in the sub-scanning direction with respect to the interval between the laser beams L₁ and L_{N} that have passed through the various lenses. Also, the width D3 is set to a value that satisfies the condition D3<D1×β, such that the laser beams L₁ and L_{N} are not incident on the light-receiving surface 207a at the same time even if the light emitting elements 1 and N (LD₁ and LD_{N}) are turned on at the same time. Note that R is the rate of fluctuation in the main scanning direction with respect to the interval between the laser beams L₁ and L_{N} that have passed through the various lenses.

Control Configuration of Image Forming Apparatus

FIG. 4 is a block diagram showing the control configuration of the image forming apparatus 100 according to the present embodiment. The image forming apparatus 100 includes, as the control configuration, a CPU 401, a laser driver 403, a clock (CLK) signal generation unit 404, an image processing unit 405, the memory 406, and a motor 407. Note that in the present embodiment, the laser driver 403, the light source 201, and the BD sensor 207 shown in FIG. 4 are included in the optical scanning apparatus 104.

A counter 402 is included in the CPU 401, and the CPU 401 performs overall control of the image forming apparatus 100 by executing a control program stored in the memory 406. The CLK signal generation unit 404 generates clock signals (CLK signals) at a predetermined frequency and outputs the generated clock signals to the CPU 401 and the laser driver 403. The CPU 401 uses the counter 402 to count the CLK signals input from the CLK signal generation unit 404 and outputs control signals to the laser driver 403 and the motor 407 in synchronization with the CLK signals.

The motor 407 is a polygon motor that drives the polygon mirror 204 so as to rotate. The motor 407 includes a speed sensor (not shown) that employs a frequency generator (FG) scheme for generating frequency signals that are proportionate to the rotation speed. The motor 407 uses the speed sensor to generate FG signals at a frequency corresponding to the rotation speed of the polygon mirror 204 and outputs the FG signals to the CPU 401. The CPU 401 measures the generation period of the FG signals input from the motor 407 based on the count value of the counter 402. When the measured generation period of the FG signals reaches a predetermined period, the CPU 401 determines that the rotation speed of the polygon mirror 204 has reached a predetermined speed.

The BD sensor 207 generates the BD signals in response to the detection of the laser beams and outputs the generated BD signals to the CPU 401 and the laser driver 403. The CPU 401 generates control signals for controlling the emission timings of the laser beams from the light emitting elements 1 to N (LD₁ to LD_{N}) based on the BD signals input from the BD sensor 207, and transmits the generated control signals to the laser driver 403. A driving current based on image data for image formation input from the image processing unit 405 (i.e., a driving current modulated according to the image data) is supplied by the laser driver 403 to each of the light emitting elements at a timing based on the control signals transmitted from the CPU 401. According to this, the laser driver 403 causes laser beams having light powers that correspond to the driving currents to be emitted from the respective light emitting elements.

Also, the CPU 401 designates a light power target value for the light emitting elements 1 to N (LD₁ to LD_{N}) with respect to the laser driver 403 and instructs with respect to the laser driver 403 to execute APC for the light emitting elements at a timing based on the input BD signals. Here, APC is an operation in which the laser driver 403 controls the light power of the laser beam emitted from each of the light emitting elements 1 to N so as to be light power that is equal to the light power target value. The laser driver 403 executes APC by adjusting the magnitude of the driving current supplied to each of the light emitting elements such that the light power of the light emitting element detected by a PD (photo diode) installed in the same package as the light emitting elements 1 to N matches the light power target value.

Paper is mainly used for the recording medium S on which an image is to be formed by the image forming apparatus. Paper contains more than a little moisture, and the amount of this moisture varies depending on the conditions of the environment in which the image forming apparatus is installed (for example, temperature, humidity, and the like). The following envisions a case in which the image forming apparatus 100 forms images on both sides (a first side, and a second side which is on the back of the first side) of the recording medium S. In this case, in the image forming process for the first side, first, moisture included in the recording medium S evaporates when the recording medium S passes through the fixing unit 113. As a result, the distances between the fibers in the recording medium S decrease, whereby the entire recording medium S contracts. Subsequently, even though the recording medium S passes through the fixing unit 113 in the image forming process for the second side as well, the recording medium S does not contract as much as it did during the image forming process for the first side since the moisture has already evaporated to a certain extent. Accordingly, executing similar image formation on the first side and the second side of the recording medium S results in images with different magnifications being formed on the respective sides.

Here, the image forming apparatus 100 of the present embodiment adjust the rotation speed of the polygon mirror 204 in a period of time after when the image formation for the first side ends and before when the image formation for the second side starts, thereby adjusting the magnification in the sub-scanning direction. Furthermore, in that same period of time, the image forming apparatus 100 adjusts the magnification in the main scanning direction by adjusting the output speed of the image data output from the image processing unit 405 to the laser driver 403. With these operations, the image forming apparatus 100 makes the magnifications of the images formed on the front side and the back side of the recording medium S uniform.

Optical Scanning Performed by Optical Scanning Apparatus Including Multiple Light Emitting Elements

As described above, in an image forming apparatus including multiple light emitting elements such as that in FIG. 7A, the laser beams L₁ to L_{N} that are emitted from the light emitting elements form images at positions S₁ to S_{N} that are different in the main scanning direction on the photosensitive drum 102. Accordingly, the writing start positions for the electrostatic latent images (images) in the main scanning direction need to coincide with each other for the light emitting elements. In this kind of image forming apparatus, for example, one BD signal is generated based on a laser beam emitted from a specific light emitting element, and using this BD signal as a reference, the relative laser emission timings for the light emitting elements are controlled based on fixed setting values that have been set in advance. With this kind of laser emission timing control based on one BD signal, it is possible to make the image writing start positions coincide with each other as long as the relative positional relationship between the image forming positions S₁ to S_{N} is constant during image formation.

However, when the light emitting elements emit laser beams, the wavelengths of the laser beams output from the light emitting elements change along with an increase in the temperature of the light emitting elements themselves. Also, due to the heat generated by the motor 407 when rotating the polygon mirror 204, the overall temperature of the optical scanning apparatus 104 increases and the optical characteristics (refractive index, etc.) of the scanning lenses 205 and 206 change. This causes the optical paths of the laser beams emitted from the light emitting elements to change. FIG. 7C shows a situation in which the image forming positions S₁ to S_{N} of the laser beams have shifted from the positions shown in FIG. 7B due to the optical paths of the laser beams emitted from the light emitting elements changing. When the relative positional relationship between the image forming positions S₁ to S_{N} changes in this way, the writing start positions in the main scanning direction for the electrostatic latent images that are to be formed by the laser beams cannot be caused to coincide with each other using the laser emission timing control which is based on one BD signal described above.

In view of this, the image forming apparatus 100 (optical scanning apparatus 104) according to the present embodiment generates two BD signals based on the laser beams emitted from two light emitting elements among the light emitting elements (LD₁ to LD_{N}), and uses the BD signals for the laser emission timing control. Specifically, the image forming apparatus 100 causes the BD sensor 207 to detect the two laser beams emitted from the light emitting elements 1 and N (LD₁ and LD_{N}), thereby causing the BD sensor 207 to generate the two BD signals. Furthermore, the image forming apparatus 100 controls the laser emission timings for the light emitting elements based on the difference in the times at which the BD sensor 207 generates the two BD signals (i.e., the difference in the laser beam detection times).

Laser Emission Timing Control Based on Two BD Signals

Next, a more detailed description will be given regarding laser emission timing control based on the two BD signals, for the multiple (N) light emitting elements (LD₁ to LD_{N}) according to the present embodiment.

In the present embodiment, when a predetermined period is reached, the CPU 401 measures the time interval between the two BD signals (pulses) generated based on the laser beams emitted from the light emitting elements 1 and N. Note that the time interval between the BD signals corresponds to the time interval in the main scanning direction (beam interval) when the laser beams emitted from the light emitting elements 1 and N scan the surface of the photosensitive drum 102. The beam interval may be measured periodically (e.g., each time 100 pages of images are formed). Note that in the period of performing beam interval measurement (beam interval measurement period), APC may be executed with respect to the light emitting elements used in the measurement (light emitting elements 1 and N in the present embodiment) before executing the measurement in order to stabilize the light power of those light emitting elements.

When the measurement in the beam interval measurement period (referred to below as simply the “measurement period”) ends, the CPU 401 controls (corrects) the beam emission timings of the light emitting elements based on the measurement result in a predetermined period (e.g., in the period up to when the next beam interval measurement is performed). Note that in a non-beam-interval-measurement period (referred to below as a “non-measurement period”), which is a period other than a measurement period, in which beam interval measurement is not performed, APC may be executed sequentially on the light emitting elements included in the light source 201 for image formation.

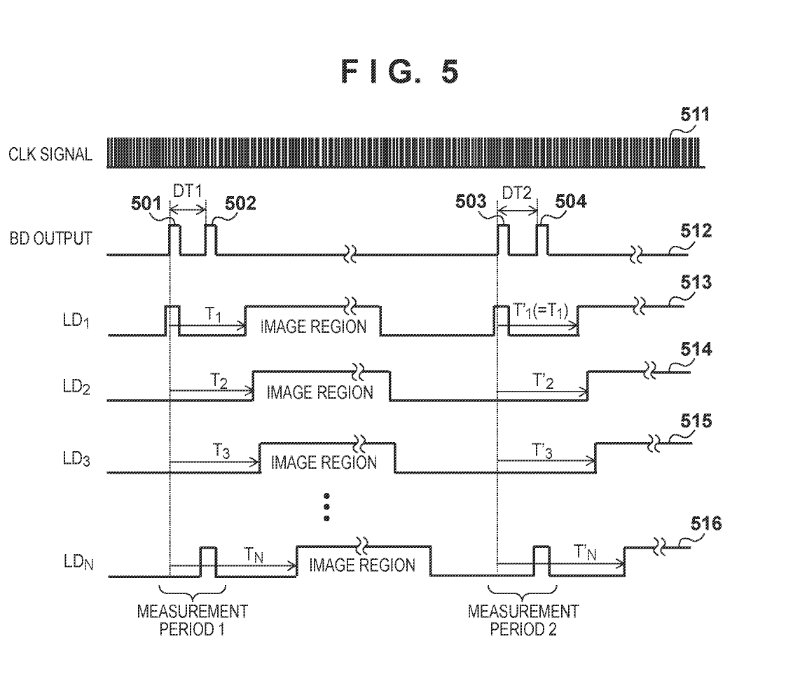

FIG. 5 is a timing chart showing the timing of operations of the optical scanning apparatus 104 according to the present embodiment. FIG. 5 shows CLK signals 511, output signals 512 of the BD sensor 207, and light powers 513 to 516 of the laser beams emitted by the light emitting elements 1, 2, 3, and N. Also, FIG. 5 shows the laser beam emission timings for the light emitting elements 1 to N and the output timings of the BD signals output from the BD sensor 207 in the case of executing the beam interval measurement. Note that two measurement periods 1 and 2 shown in FIG. 5 respectively correspond to periods of performing measurement using the BD sensor 207 for adjusting the emission timings at which the light emitting elements emit laser beams (light beams) when an electrostatic latent image is to be formed on the surface of the photosensitive drum 102.

In FIG. 5, when the measurement periods 1 and 2 are reached, the measurement of the beam interval using the light emitting elements 1 and 2 is performed in the measurement periods. In the measurement periods, the CPU 401 controls the laser driver 403 such that the laser beams are emitted at a predetermined interval from the light emitting elements 1 and N that are used for the measurement, and executes one beam interval measurement in one laser beam scanning period.

Specifically, the CPU 401 controls the laser driver 403 to sequentially emit the laser beams (first and second light beams) at the predetermined interval from the light emitting elements 1 and N among the light emitting elements (light emitting elements 1 to N). According to this, in the measurement period 1, BD signals 501 and 502 that correspond to the light emitting elements 1 and 2 respectively are generated by the BD sensor 207 and output to the CPU 401 and the laser driver 403. Also, in the measurement period 2, BD signals 503 and 504 that correspond to the light emitting elements 1 and N respectively are generated by the BD sensor 207 and output to the CPU 401 and the laser driver 403. The CPU 401 measures a time interval (generation time difference) DT1 between the BD signal 501 and the BD signal 502 in the measurement period 1 and measures the time interval DT2 between the BD signal 503 and the BD signal 504 in the measurement period 2, as count values C_{DT} based on the counter 402.

In the measurement period 1, in response to the BD signal 501 being input from the BD sensor 207, the CPU 401 starts the count of the CLK signal 511. Subsequently, in response to the BD signal 502 being input from the BD sensor 207, the CPU 401 ends the count of the CLK signal 511 and generates the count value C_{DT}. The count value C_{DT} is a value indicating the time interval DT1 between the BD signal 501 and the BD signal 502, shown in FIG. 5. Note that in the measurement period 2 as well, the CPU 401 similarly generates the count value C_{DT} indicating the time interval DT2 between the BD signal 503 and the BD signal 504.

A beam emission timing control method using the beam interval measurement result will be described next. In the present embodiment, a reference value that is to be used as a reference for the beam emission timing control for the light emitting elements, and timing values that are set in association with the reference value and indicate the laser emission timings for the light emitting elements are stored in advance in the memory 406. By adjustment (measurement) in the assembly step at the factory, the reference value and the timing values are generated as initial values for the laser emission control for the light emitting elements and stored in the memory 406. Also, in the laser emission timing control, for each of the light emitting elements 1 to N, the laser emission timing is adjusted using a value obtained by correcting the timing value according to the difference between the beam interval measurement result and the reference value stored in the memory 406.

In the present embodiment, a reference count value C_{ref} is stored in the memory 406 as the reference value for controlling the beam emission timings of the light emitting elements. Also, count values C₁ to C_{N} for the light emitting elements 1 to N which are in association with the reference count value C_{ref} are stored in the memory 406 as the timing values for controlling the beam emission timings of the light emitting elements.

The reference count value C_{ref} and the count values C₁ to C_{N} are values that are obtained by measurement corresponding to different light power target values at the time of factory adjustment. The reference count value C_{ref} is a value that corresponds to a time interval T_{ref} between BD signals that are generated in the image forming apparatus 100 (optical scanning apparatus 104) in a specific state and correspond to the light emitting elements 1 and N. In the present embodiment, the reference count value C_{ref} is a value that corresponds to the time interval between BD signals generated in an initial state at the time of factory adjustment, as described above. The count values C₁ to C_{N} are values for causing the writing start positions in the main scanning direction for the electrostatic latent images corresponding to the light emitting elements to coincide with each other in the case where the time interval between the generated BD signals is T_{ref}. In this way, T_{ref} (C_{ref}) is the reference value for the time interval between the BD signals and corresponds to the reference value that serves as the reference for adjusting the laser emission timings.

The reference count value C_{ref} and the count values C₁ to C_{N} can be set in advance as follows. First, an optical system is envisioned in which, when two laser beams emitted from two light emitting elements used for measurement scan the photosensitive drum, the time interval of detection of the two laser beams by the BD sensor 207 (detection time interval) is equal to the time interval of scanning by the two laser beams on the photosensitive drum 102 (scanning time interval). In such a case, one of the detection time interval T_{ref} of laser beams by the BD sensor 207, and the scanning time interval on the photosensitive drum 102 may be measured at the time of factory adjustment, the other is derived based on that measurement result, and thereby C_{ref} and C₁ to C_{N} may be set.

On the other hand, errors that are dependent on variation in the spot size of the corresponding laser beams on the light-receiving surface 207a, variation in the light power, or the like sometimes occur in the detection time interval of laser beams by the BD sensor 207. In such a case, the interval between the image forming positions of the laser beams on the photosensitive drum 102 are measured at the same time as T_{ref} is measured at the time of factory adjustment. Furthermore, C_{ref} and C₁ to C_{N} may be set based on these measurement results such that the variation as described above is canceled out. Also, in the case of an optical system in which the detection time interval (scanning speed) of laser beams by the BD sensor 207 and the scanning time interval (scanning speed) on the photosensitive drum 102 are different, C_{ref} and C₁ to C_{N} may be set similarly such that the difference between the scanning speeds is canceled out.

(In Case of C_{DT}=C_{ref})

Control for the laser emission timings of the light emitting elements (LDₙ) based on the count value C_{DT} obtained by the above-described measurement will be described next. First, it is presumed that the count value C_{DT} obtained by the measurement in the measurement period 1 shown in FIG. 5 is equal to the reference count value C_{ref} that was stored in advance in the memory 406. This means that the measurement result DT1 for the time interval between the BD signals 501 and 502 indicated by the count value C_{DT} is equal to the reference value T_{ref} (DT1=T_{ref}). In this case, the count values C₁ to C_{N} that were stored in advance in the memory 406 are directly used to control the laser emission timings of the light emitting elements, and it is thereby possible make the image writing start positions for the laser beams coincide with each other.

The timing at which the BD signal 501 was generated is used as a reference by the CPU 401 to control the laser driver 403 such that the light emitting elements 1 to N (LD₁ to LD_{N}) are sequentially turned on (emit light) at the emission timings corresponding to the count values C₁ to C_{N}. Here, T₁ to T_{N} shown in FIG. 5 are amounts of time corresponding to the count values C₁ to C_{N}. The CPU 401 starts the count of the CLK signal from the timing at which the BD signal 501 was generated, and turns on the light emitting element 1 in response to the count value reaching C₁ (when T₁ has elapsed). Next, the CPU 401 turns on the light emitting element 2 in response to the count value reaching C₂ (when T₂ has elapsed). The CPU 401 performs similar control with respect to the other light emitting elements as well, and finally turns on the light emitting element N in response to the count value reaching C_{N} (when T_{N} has elapsed).

By doing so, the CPU 401 adjusts the laser emission timings for the light emitting elements 1 to N such that the positions at which the forming of the electrostatic latent images starts coincide with each other between the multiple main scanning lines on the photosensitive drum 102 that are scanned by the light emitting elements 1 to N. According to this, the writing start positions for the images to be formed by the laser beams emitted from the light emitting elements 1 to N in the main scanning direction can be caused to coincide with each other.

Here, it is possible to store only the count values C₁ and C_{N} that correspond to the light emitting elements 1 and N as timing values in the memory 406. That is to say, the count values C₂ to C_{N-1} corresponding to light emitting elements n (2≦n≦N−1), which are positioned between the light emitting element 1 and the light emitting element N shown in FIG. 3A, may be obtained based on Equation (1) below rather than being stored in the memory 406. Specifically, the CPU 401 may calculate the count value Cₙ for controlling the laser emission timing for the light emitting element n (2≦n≦N−1) using the following equation:

Cₙ=C₁+(C_{N}−C₁)ₓ(n−1)/(N−1)=C₁×(N−n)/(N−1)+C_{N}×(n−1)/(N−1) (1)

For example, in the case where the light source 201 includes four light emitting elements 1 to 4 (LD₁ to LD₄), the CPU 401 calculates the count values C₂ and C₃ corresponding to the light emitting elements 2 and 3 based on the following equations.

C₂=C₁+(C₄−C₁)×1/3=C₁×2/3+C₄×1/3 (2)

C₃=C₁+(C₄−C₁)ₓ₂/3=C₁×1/3+C₄×2/3 (3)

Thus, the laser emission timings for the light emitting elements may be determined by performing an interpolation calculation based on the count values C₁ and C_{N} (T₁ and T_{N}) that correspond to the light emitting elements 1 and N, such that the laser emission timings of the light emitting elements 1 to N have equal time intervals.

(In Case of C_{DT}≠C_{ref})

Next, it is presumed that a deviation from the reference count value C_{ref} that was stored in advance in the memory 406 has occurred in the count value C_{DT} obtained by the measurement in the measurement period 2 shown in FIG. 5. This means that the measurement result DT2 for the time interval between the BD signals 503 and 504 indicated by the count value C_{DT} is not equal to the reference value T_{ref} (DT2≠T_{ref}). In this case, the CPU 401 corrects the count values C₁ to C_{N} based on the difference between the count value C_{DT} and the reference count value C_{ref}, thereby deriving the count values C′₁ to C′_{N} for controlling the laser emission timings of the light emitting elements. By controlling the laser emission timings of the light emitting elements using the derived count values C′₁ to C′_{N}, it is possible to make the image writing start positions for the laser beams coincide with each other.

Specifically, the CPU 401 first sets the count value C₁ stored in the memory 406 to the count value C′₁ for controlling the laser emission timing of the light emitting element 1 (T′₁=T₁). Note that T′₁ to T′N shown in FIG. 5 are amounts of time corresponding to the count values C′₁ to C′_{N} respectively. Next, the CPU 401 uses the following equation to correct C_{N} based on the difference between the count value C_{DT} and the reference count value C_{ref}, and thereby sets the count value C′_{N} (T′_{N}) for controlling the laser output timing of the light emitting element N.

C′_{N}=C_{N}+K(C_{DT}−C_{ref}) (K is any coefficient, including 1) (4)

Here, the coefficient K is a coefficient for performing weighting on the amount of change from the reference value (C_{DT}−C_{ref}) for the detection time interval of laser beams by the BD sensor 207, and the coefficient K can be determined according to the characteristics of the optical system. For example, K=1 is used in an optical system in which, when two laser beams emitted from two light emitting elements used for measurement scan the photosensitive drum 102, the detection time interval of the laser beams by the BD sensor 207 is equal to the scanning time interval on the photosensitive drum 102. On the other hand, in an optical system in which the detection time interval (scanning speed) of the laser beams by the BD sensor 207 and the scanning time interval (scanning speed) on the photosensitive drum 102 are different, the coefficient K is determined according to the ratio between the detection time interval and the scanning time interval.

An example of an optical system in which the coefficient K is determined to be a value other than 1 (K≠1) is the configuration of the optical scanning apparatus 104 shown in FIG. 2B. In the optical scanning apparatus 104 shown in FIG. 2B, after passing through the scanning lens 205, the laser beams are reflected by the reflection mirror 208 and form images on the light-receiving surface 207a of the BD sensor 207 by the BD lens 209. In this case, the laser beam that scans the BD sensor 207 passes through the BD lens 209, whereas the laser beam that scans the photosensitive drum 102 passes through the scanning lens 206. In this way, when laser beams are to scan scanning targets via independent lenses, the scanning speed on the BD sensor 207 and the scanning speed on the photosensitive drum 102 can be different speeds depending on the relationship between the magnification of the lens and the distance of the focal point from the lens. Accordingly, in the optical system shown in FIG. 2B, the coefficient K may be determined according to the ratio between the scanning speeds as described above.

Note that in an optical system other than the optical system shown in FIG. 2B as well, there is a probability that the scanning speed on the BD sensor 207 and the scanning speed on the photosensitive drum 102 are to be different speeds due to an optical component attachment error in the assembly step or the like. In such a case, the coefficient K may be determined experimentally using the optical system. Also, the coefficient K may be derived and determined for each image forming apparatus (optical scanning apparatus) at the time of factory adjustment. Note that the coefficient K may be determined by, for example, changing the temperature of the measuring environment and deriving the scanning speed on the BD sensor 207 and the scanning speed on the photosensitive drum 102 before and after the temperature change.

Next, the CPU 401 may use an interpolation calculation based on Equations (1) to (3) to determine the count values C′ₙ for controlling the laser emission timings of the light emitting elements n (2≦n≦N−1) that are other than the light emitting elements 1 and N. That is to say, an interpolation calculation based on the count values C′₁ and C′_{N} that have been set for the light emitting elements 1 and N is performed by the CPU 401 such that the laser emission timings of the light emitting elements 1 to N have equal time intervals. According to this, the corrected laser emission timings C′ₙ (T′ₙ) may be set for the light emitting elements 2 to (N−1).

Thereafter, the timing at which the BD signal 503 was generated is used as a reference by the CPU 401 to control the laser driver 403 such that the light emitting elements 1 to N (LD₁ to LD_{N}) are sequentially turned on at the emission timings corresponding to the count values C₁ to C_{N}. Here, T′₁ to T′_{N} shown in FIG. 5 are amounts of time corresponding to the count values C′₁ to C′_{N}. The CPU 401 starts the count of the CLK signal from the timing at which the BD signal 501 was generated, and turns on the light emitting element 1 in response to the count value reaching C′₁ (when T′₁ has elapsed). Next, the CPU 401 turns on the light emitting element 2 in response to the count value reaching C′₂ (when T′₂ has elapsed). The CPU 401 performs similar control for the other light emitting elements as well, and finally turns on the light emitting element N in response to the count value reaching C′_{N} (when T′_{N} has elapsed).

By doing so, the CPU 401 adjusts the laser emission timings of the light emitting elements 1 to N such that the positions at which the forming of the electrostatic latent images starts coincide with each other between the multiple main scanning lines on the photosensitive drum 102 that are scanned by the light emitting elements 1 to N. According to this, even when the measured value for the time interval between the BD signals changes from the reference value, the writing start positions for the images to be formed by the laser beams emitted from the light emitting elements 1 to N can be caused to coincide with each other in the main scanning direction.

Relationship Between Laser Beam Scanning Speed and Beam Interval Measurement

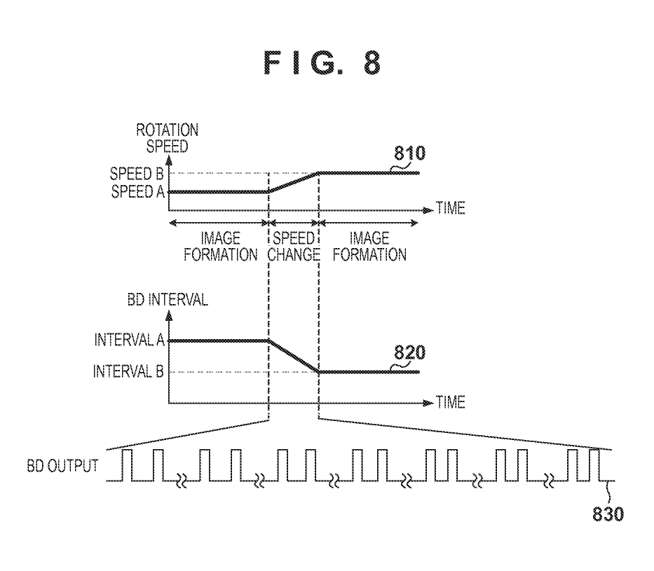

If the above-described beam interval measurement is executed while the rotation speed of the polygon mirror 204 is being adjusted (while speed change control is in progress) in the optical scanning apparatus 104, there is a possibility that the accuracy in measuring the time interval between the two BD signals output from the BD sensor 207 will deteriorate. Here, FIG. 8 is a diagram showing an example of the relationship between a rotation speed 810 of the polygon mirror 204 in the optical scanning apparatus 104 and a time interval 820 between the two BD signals output from the BD sensor 207. FIG. 8 shows a case in which the image forming apparatus 100 performs image formation on a certain recording medium in a state where the polygon mirror 204 is being rotated at a constant speed A (state of constant speed control), subsequently causes the rotation speed 810 to change to speed B (changes speed), and then furthermore performs image formation on a recording medium subsequent to the above-mentioned certain recording medium. Also, FIG. 8 shows a case in which beam interval measurement is performed periodically while the above-described rotation speed control for the polygon mirror 204 is being performed. Note that while image formation is in progress, the rotation speed 810 of the polygon mirror 204 is kept at a constant speed.

As shown in FIG. 8, in the period in which the rotation speed 810 of the polygon mirror 204 is constant at speed A or B, the time interval 820 between the BD signals output from the BD sensor 207 is kept constant. However, while the rotation speed 810 of the polygon mirror 204 changes, the time interval 820 between the BD signals gradually changes, and as the rotation speed 810 increases, the time interval 820 becomes shorter.

The adjustment (acceleration or deceleration) of the rotation speed of the polygon mirror 204 is executed such that the magnifications of the images formed on the front and back sides of the recording medium S are uniform in the case where the image forming apparatus 100 executes double-sided printing for forming images on both sides of the recording medium S as described above, for example. Similarly, the rotation speed of the polygon mirror 204 is adjusted and temporarily becomes unstable also in the case where the rotation speed of the polygon mirror 204 is temporarily accelerated or decelerated so as to adjust the rotation phase of the polygon mirror 204. If the beam interval measurement is performed while this kind of adjustment of the rotation speed of the polygon mirror 204 is in progress, the result of measuring the time interval between two BD signals changes in the manner shown in FIG. 8.

This kind of change in the time interval 820 is mistakenly determined to be a change in the time interval between BD signals caused by a change in the temperature of the optical scanning apparatus 104 as described above at the time of controlling the laser emission timing. As a result, the laser emission timing cannot be controlled accurately based on the result of measuring the time interval between the BD signals, and the writing start positions for the image formed using the laser beams emitted from the light emitting elements 1 to N cannot be caused to coincide with each other in the main scanning direction.

In order to deal with this problem in the present embodiment, the deterioration in the measurement accuracy is suppressed by appropriately controlling the execution timing for the beam interval measurement. Specifically, the execution timing of the beam interval measurement is set in the period in which the rotation speed of the polygon mirror 204 (i.e. the scanning speed when the laser beams emitted from the light emitting elements 1 to N scan the photosensitive drum 102) is constant. That is to say, by controlling the driving of the motor 407, the CPU 401 executes the beam interval measurement, not in the period in which speed change control for causing the rotation speed of the polygon mirror 204 to accelerate or decelerate toward a target speed is performed, but in the period in which constant speed control for keeping the rotation speed at a target speed is performed. Furthermore, the CPU 401 controls the emission timings of the light beams that are based on the image data for the light emitting elements, based on the time interval between the BD signals that were generated in response to the two light beams incident on the BD sensor 207 in the period of executing constant speed control.

Note that the beam interval measurement in the present embodiment does not refer only to control for measuring the beam interval by causing the light emitting elements to emit laser beams such that they are incident on the BD sensor 207 only while later-described constant speed control, in which the polygon mirror 204 rotates at a constant speed, is in progress. For example, the beam interval measurement in the present embodiment may be such that laser beams are emitted from the light emitting elements so as to be incident on the BD sensor 207 while the constant speed control or the speed change control for the polygon mirror 204 is in progress. In such a case, control is possible in which only detection signals corresponding to the laser beams that were incident on the BD sensor 207 while the constant speed control for the polygon mirror 204 was in progress are employed as the beam interval measurement result.

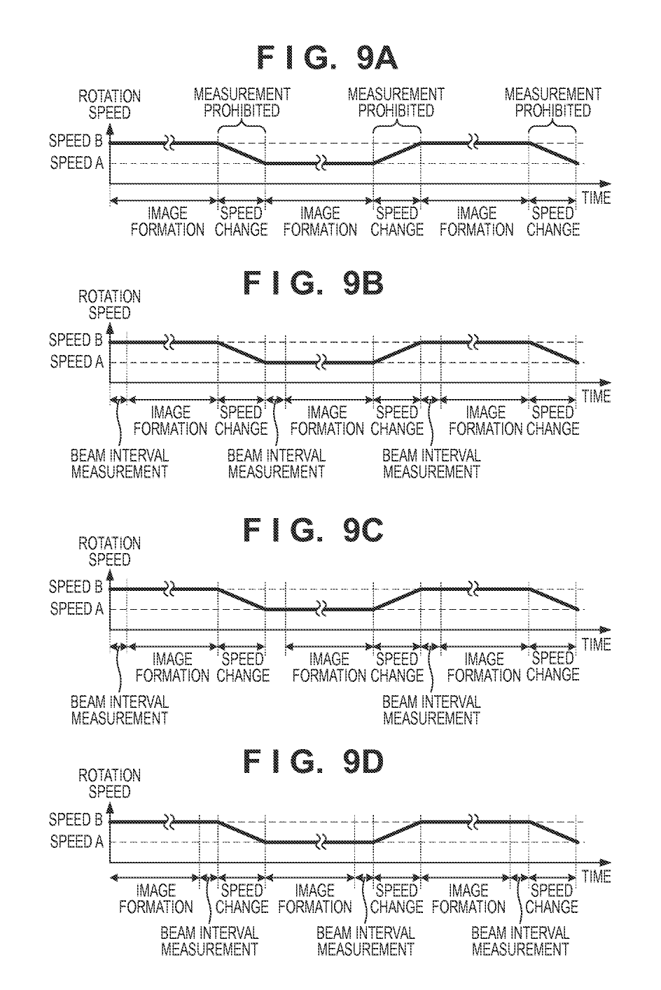

FIGS. 9A to 9D are diagrams showing examples of execution timings for beam interval measurement in the image forming apparatus 100 according to the present embodiment. FIGS. 9A to 9D show cases of performing image formation while the rotation speed of the polygon mirror 204 (i.e., the scanning speed when the lasers L₁ to L_{N} scan the photosensitive drum 102) is switched between speed A and speed B, which is faster than speed A, at constant intervals. Note that it is possible to think of speed A as the first rotation speed and speed B as the second rotation speed, and it is possible to think of speed B as the first rotation speed and speed A as the second rotation speed. As shown in FIG. 9A, the image forming apparatus 100 prohibits the execution of beam interval measurement while control for changing (accelerating or decelerating) the rotation speed of the polygon mirror 204 from the first rotation speed to the second rotation speed (or from the second rotation speed to the first rotation speed) is in progress. Also, the image forming apparatus 100 executes the beam interval measurement in a constant speed control period in which control for causing the rotation speed to accelerate or decelerate is not being performed, or in other words, in a constant speed control period in which the rotation speed of the polygon mirror 204 is constant at a target speed, the period being before or after when the speed change control for changing from the first rotation speed to the second rotation speed (or from the second rotation speed to the first rotation speed) has been performed and before when image formation on the next recording medium is performed.

FIGS. 9B to 9D show cases of executing the beam interval measurement at different timings.

FIGS. 9B and 9C show cases of executing beam interval measurement at a timing in the period from when the acceleration or deceleration of the rotation speed of the polygon mirror 204 is complete, until when the scanning of the laser beams with respect to an image region on which the electrostatic latent images are to be formed on the photosensitive drum 102 is started. In particular, FIG. 9B shows a case of executing measurement while the rotation speed of the polygon mirror 204 is constant at speed A (first target speed) and speed B (second target speed). Note that in the present embodiment, control by the CPU 401 for maintaining the rotation speed of the polygon mirror 204 at speed A is referred to as first speed control, and control by the CPU 401 for maintaining the rotation speed of the polygon mirror 204 at speed B is referred to as second speed control. Also, acceleration control by the CPU 401 for causing the rotation speed of the polygon mirror 204 to accelerate from speed A to speed B, and deceleration control by the CPU 401 for causing the rotation speed of the polygon mirror 204 to decelerate from speed B to speed A, are collectively referred to as speed change control. By performing measurement at this kind of timing, it is possible to cause the measurement result to be reflected in the control of the beam emission timings for scanning of the image region after the measurement. In this case, as described above, the beam emission timings for the light emitting elements may be controlled using the measurement result, and the reference count value C_{ref} and the count values C₁ to C_{N} that have been stored in the memory 406.

On the other hand, FIG. 9C shows a case of executing beam interval measurement while the rotation speed of the polygon mirror 204 is constant at speed B (first scanning speed) out of the two different speeds A and B, and not executing measurement while the speed is constant at speed A (second scanning speed). In this case, the CPU 401 performs beam emission timing control as described above while the rotation speed of the polygon mirror 204 is constant at speed B. On the other hand, while the rotation speed of the polygon mirror 204 is constant at speed A, the CPU 401 controls the beam emission timings according to the result of the beam interval measurement in the period in which the rotation speed was speed B, and to the ratio between speed B and speed A.

Specifically, in the period in which the rotation speed is speed A, count values C′ₙ for controlling the light emitting elements n are obtained using the following equation, whereby the count value C_{DT} obtained at speed B is corrected and used for controlling the beam emission timings at speed A.

C′ₙ=T{Cₙ+K(C_{DT}−C_{ref})} (K is any coefficient, including 1) (5)

Here, T represents the ratio between speed B and speed A. In this way, the beam emission timings may be controlled using a value obtained by correcting the timing value Cₙ according to the ratio of the two speeds, and the difference between the C_{DT} corresponding to the measurement result of the time interval between the BD signals and the reference count value C_{ref}. According to this kind of control, the writing start positions for the images to be formed using the laser beams can be caused to coincide with each other at each of the two rotation speeds even in the case where the beam interval measurement is executed at only one of the two rotation speeds.

Next, FIG. 9D shows a case of executing the beam interval measurement at a timing in the period from when the scanning of the laser beams with respect to the image region in which the electrostatic latent images are to be formed on the photosensitive drum 102 ends, until when the acceleration or deceleration of the rotation speed of the polygon mirror 204 is started. In this case, the measurement result cannot be directly applied to the control of the beam emission timing since the rotation speed of the polygon mirror 204 changes after the beam interval measurement is executed. In this case, similarly to the case shown in FIG. 9C, the CPU 401 may control the beam emission timings according to the result of the beam interval measurement in a period in which the rotation speed of the polygon mirror 204 is constant at one speed and in a period in which the rotation speed is at another speed, and to the ratio between the two speeds.

Image Formation Processing Performed by the Image Forming Apparatus

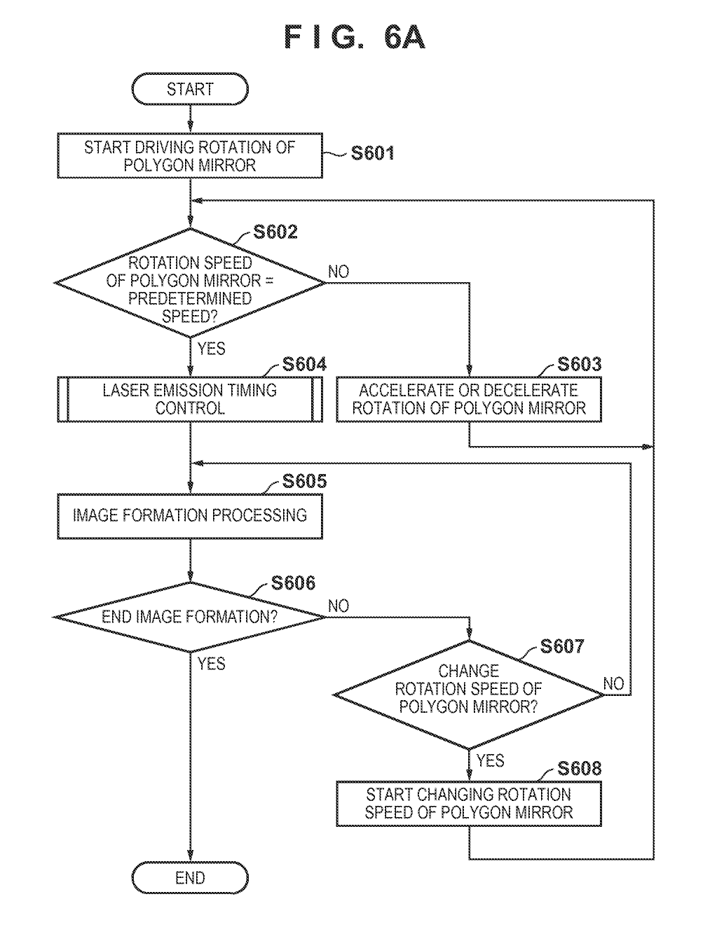

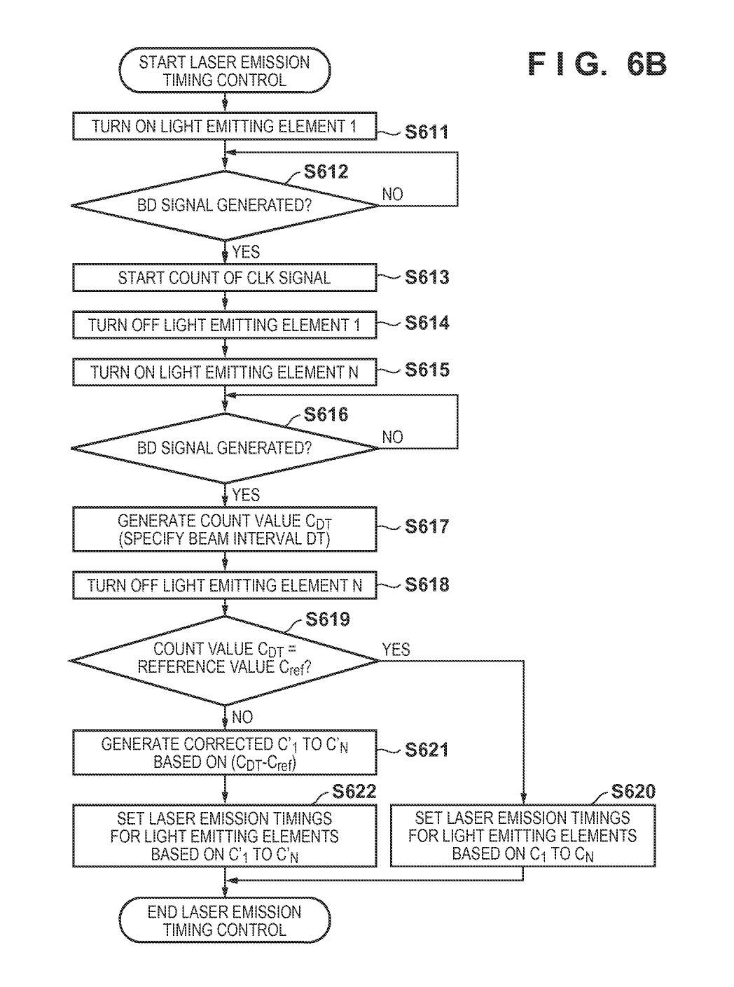

FIG. 6A is a flowchart showing a procedure of image formation processing executed by the image forming apparatus 100 according to the present embodiment, and it corresponds to the processing that was described with reference to FIGS. 9B and 9C. The processing of the steps shown in FIG. 6A is realized in the image forming apparatus 100 by the CPU 401 reading out a control program stored in the memory 406 and executing it. The processing of step S601 starts in response to image data being input to the image forming apparatus 100.

In step S601, in response to the input of the image data, the CPU 401 starts the driving of the motor 407, thereby causing the rotation of the polygon mirror 204 to start, and in step S602, the CPU 401 determines whether or not the rotation speed of the polygon mirror 204 is being controlled so as to be a predetermined rotation speed (target speed). If it is determined in step S602 that that the rotation speed of the polygon mirror 204 is not being controlled so as to be the predetermined speed, the CPU 401 advances the process to step S603, causes the rotation of the polygon mirror 204 to accelerate such that the rotation speed approaches the predetermined rotation speed, and performs the determination processing of step S602 once again. If it is determined in step S602 that the rotation speed of the polygon mirror 204 is being controlled so as to be the predetermined rotation speed, the CPU 401 advances the process to step S604. Note that in step S602, if the speed fluctuation amount of the polygon mirror 204 falls within a predetermined range and the rotation speed of the polygon mirror 204 is shifting the vicinity of the predetermined rotation speed, the CPU 401 may determine that the rotation speed of the polygon mirror 204 is being controlled so as to be the predetermined rotation speed. Also, if the speed fluctuation amount of the polygon mirror 204 does not fall within the predetermined range, the CPU 401 may determine that the rotation speed of the polygon mirror 204 is not being controlled so as to be the predetermined rotation speed.

In step S604, the CPU 401 controls the laser emission timings of the light emitting elements 1 to N in accordance with the procedure shown in FIG. 6B using the two BD signals generated based on the laser beams emitted from the light emitting elements 1 and N. Note that the present embodiment has described an example in which the CPU 401 executes the processing of step S604 (FIG. 6B), but the processing of step S604 may be executed by a control unit provided independently from the CPU 401 in the laser driver 403. In this case, the control unit in the laser driver 403 may operate in accordance with an instruction from the CPU 401 and executes the beam interval measurement based on the CLK signal input from the CLK signal generation unit 404 and the BD signals input from the BD sensor 207. Also, the control unit in the laser driver 403 may control the laser emission timings in accordance with an instruction from the CPU 401.

As shown in FIG. 6B, in step S611, the CPU 401 first causes the laser driver 403 to turn on the light emitting element 1. Subsequently, in step S612, based on the output from the BD sensor 207, the CPU 401 determines whether or not a BD signal has been generated according to the laser beam emitted from the light emitting element 1. As long as it is determined in step S612 that a BD signal has not been generated, the CPU 401 repeats the determination processing of step S612, and upon determining that a BD signal has been generated, the CPU 401 advances the process to step S613. In response to the generation of the BD signal, the CPU 401 starts the count of the CLK signals using the counter in step S613 and causes the laser driver 403 to turn off the light emitting element 1 in step S614.

Next, in step S615, the CPU 401 causes the laser driver 403 to turn on the light emitting element N. Subsequently, based on the output from the BD sensor 207, the CPU 401 determines in step S616 whether or not a BD signal has been generated according to the laser beam emitted from the light emitting element N. As long as it is determined in step S616 that a BD signal has not been generated, the CPU 401 repeats the determination processing of step S616, and upon determining that a BD signal has been generated, the CPU 401 advances the process to step S617. In step S617, the CPU 401 generates the count value C_{DT} by sampling the count value of the CLK signals using the counter 402, and in step S618, the CPU 401 causes the laser driver 403 to turn off the light emitting element N.

Next, in step S619, the CPU 401 compares the count value C_{DT} and the reference count value (reference value) C_{ref} to determine whether or not C_{DT}=C_{ref}. If it is determined that C_{DT}=C_{ref}, the CPU 401 advances the process to step S620. In step S620, as described above, the CPU 401 sets the laser beam emission timings T₁ to T_{N} for the light emitting elements based on C₁ to C_{N} using, as a reference, the generation time of the BD signal generated according to the laser beam L₁ emitted from the light emitting element 1.

On the other hand, if it is determined in step S619 that C_{DT}≠C_{ref}, the CPU 401 advances the process to step S621. In step S621, the CPU 401 calculates C_{cor}=C_{DT}−C_{ref}, corrects C₁ to C_{N} as described above based on C_{cor}, and thereby generates C′₁ to C′_{N}. Furthermore, in step S622, as described above, the CPU 401 sets the laser beam emission timings T₁ to T_{N} for the light emitting elements based on C′₁ to C′_{N} using as a reference, the generation time of the BD signal generated according to the laser beam L₁ emitted from the light emitting element 1.

In this manner, the CPU 401 ends the laser emission timing control for the light emitting elements 1 to N using the two BD signals generated based on the laser beams emitted from the light emitting elements 1 and N in step S604, and advances the process to step S605.

Returning to FIG. 6A, in step S605, the CPU 401 starts image formation processing based on the input image data. Specifically, the CPU 401 executes an exposure process in which the photosensitive drum 102 is exposed by causing the laser beams L₁ to L_{N} that are based on the image data to be emitted from the light emitting elements 1 to N in accordance with the laser emission timings set in step S620 or step S622. Furthermore, the CPU 401 forms an image on the recording medium S by executing other processes such as a developing process and a transfer process.

Each time image formation for one page is executed thereafter, the CPU 401 determines in step S606 whether or not to end the image formation. For example, if the image formation for the front side (first side) of the recording medium ends and the image formation for the back side (second side) is to be executed successively, the CPU 401 determines that the image formation is not to end and advances the process to step S607. On the other hand, if it is determined that the image formation is to end, the CPU 401 ends the series of processing shown in FIG. 6A.

In step S607, the CPU 401 determines whether or not the rotation speed of the polygon mirror 204 needs to be changed. If it is determined that the rotation speed does not need to be changed, the CPU 401 returns the process to step S605 and continues the image formation processing, whereas if it is determined that the rotation speed needs to be changed, the CPU 401 advances the process to S608. In step S608, the CPU 401 starts the speed control for the motor 407 in order to change the rotation speed of the polygon mirror 204 and then returns the process to step S602. In steps S602 and S603, the CPU 401 controls the rotation of the polygon mirror 204 to accelerate or decelerate until the rotation speed of the polygon mirror 204 reaches the target speed.

### MODIFIED EXAMPLE

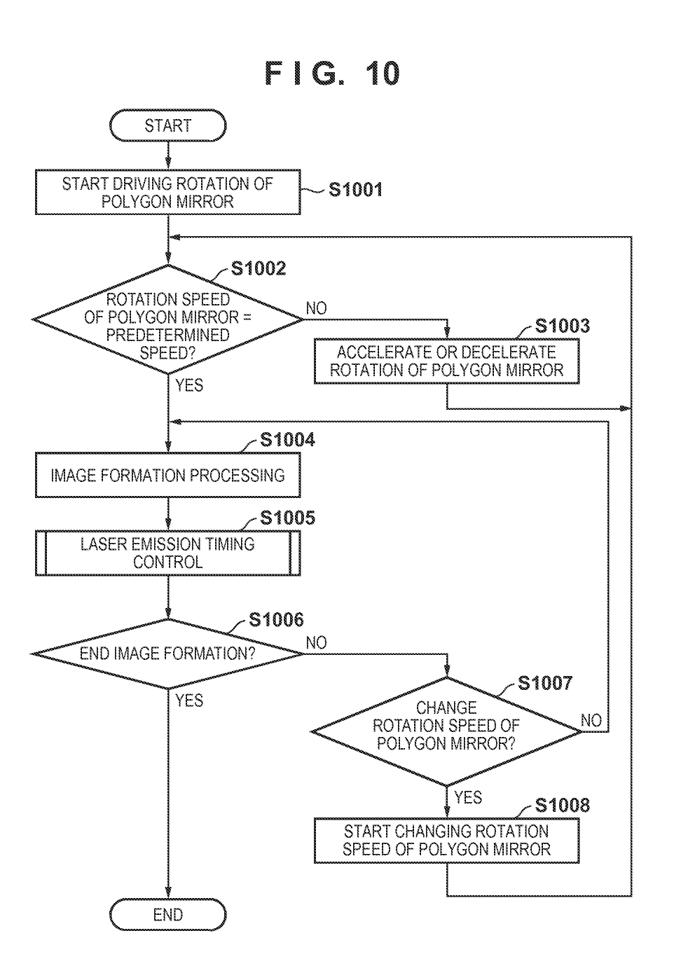

In the case of applying the processing described with reference to FIG. 9D to the image forming apparatus 100, image formation processing is executed according to a procedure that follows the flowchart shown in FIG. 10 rather than that in FIG. 6A. FIG. 10 is a flowchart showing a procedure of image formation processing executed by the image forming apparatus 100 according to the present embodiment, and it corresponds to the processing that was described with reference to FIG. 9D. FIG. 10 differs from FIG. 6A in particular in that the image formation processing (step S1004) is executed before the laser emission timing control (step S1005). In steps S1001 to S1003 in FIG. 10, the CPU 401 executes processing similar to that in steps S601 to S603. Also, processing that is similar to that in step S605 is executed in step S1004, and processing that is similar to that in step S604 and steps S606 to S608 is performed in steps S1005 to S1008. Note that when performing the laser emission timing control in step S1005, the CPU 401 performs the laser emission timing control further using the ratio between the two speeds A and B as described above.

The above-described embodiment described an image forming apparatus that changes the rotation speed of the polygon mirror 204 in order to match the magnifications of images formed on the front and back sides of a recording medium S, but the mode of implementation is not limited to this. For example, the above-described embodiment may be applied also to an image forming apparatus that changes the rotation speed of the polygon mirror 204 according to the grammage of the recording medium.

For example, it is envisioned that the recording medium is divided into the following types (paper types): regular paper 1 (grammage of 60 to 63 g/m²), regular paper 2 (grammage of 64 to 90 g/m²), thick paper 1 (grammage of 91 to 105 g/m²), and thick paper 2 (grammage of 106 to 128 g/m²). Thick paper 1 and thick paper 2 have larger grammages than regular paper 1 and regular paper 2. As the grammage is larger, the amount of time for the recording medium to pass through the fixing apparatus needs to be larger in order to ensure that the toner image is fixed to the recording medium. For this reason, the image forming apparatus makes the paper conveyance speed and the processing speed of the image forming processes in the case of performing image formation on thick paper slower than the paper conveyance speed and the processing speed of the image forming processes in the case of performing image formation on regular paper.

The image forming apparatus controls the rotation speed of the polygon mirror so as to be a rotation speed that corresponds to the processing speed. In the case of performing image formation on regular paper and thick paper consecutively, the image forming apparatus executes change control for the rotation speed of the polygon mirror. The above-described embodiment can be applied to such a case.

As described above, the image forming apparatus 100 according to the present embodiment executes beam interval measurement in a period in which the rotation speed of the polygon mirror 204 (scanning speed) is constant. That is to say, the image forming apparatus 100 can suppress deterioration in the measurement accuracy by executing the beam interval measurement in a state where the polygon mirror 204 rotates in a stable manner. As a result, it is possible to improve the accuracy of the beam emission timing control. According to this, the writing start positions for the images to be formed using laser beams emitted from the light emitting elements 1 to N can be caused to coincide with each other in the main scanning direction even in the case of performing image formation while changing the rotation speed of the polygon mirror 204 as appropriate.

While the present invention has been described with reference to embodiments, it is to be understood that the invention is not limited to the disclosed embodiments.

This application claims the benefit of Japanese Patent Application No. 2013-137469, filed Jun. 28, 2013, and No. 2014-096226, filed May 7, 2014, which are hereby incorporated by reference herein in their entirety.

What is claimed is:

1. An image forming apparatus that uses toner to develop an electrostatic latent image that is formed on a photosensitive member by exposing the photosensitive member using a plurality of light beams, and forms an image on a recording medium by transferring a toner image developed on the photosensitive member onto the recording medium, the image forming apparatus comprising:
a light source including a plurality of light emitting elements that each emit a light beam so as to form an electrostatic latent image on the photosensitive member;
a rotating polygonal mirror configured to deflect the plurality of light beams emitted from the plurality of light emitting elements such that the plurality of light beams scan the photosensitive member;
a detection unit provided on a scanning path of the plurality of light beams deflected by the rotating polygonal mirror, for outputting a detection signal indicating that a light beam has been detected due to the light beam deflected by the rotating polygonal mirror being incident on the detection unit;
a speed control unit configured to execute speed change control for accelerating or decelerating a rotation speed of the rotating polygonal mirror toward a target speed, and constant speed control for maintaining the rotation speed at the target speed, the target speed including at least a first rotation speed and a second rotation speed that is different from the first rotation speed, and the first and second rotation speeds being rotation speeds of the rotating polygonal mirror when forming an electrostatic latent image for forming a toner image that is to be transferred onto a recording medium;
a measuring unit configured to control the light source such that first and second light beams from first and second light emitting elements among the plurality of light emitting elements are sequentially incident on the detection unit, and to measure a time interval between detection signals generated according to the first and second light beams that are incident on the detection unit in a period of executing the constant speed control for maintaining the rotation speed at the second rotation speed, the period being before or after a period in which the speed change control for changing from the first rotation speed to the second rotation speed is performed by the speed control unit after an electrostatic latent image that corresponds to one recording medium has been formed and being before an electrostatic latent image that corresponds to a recording medium subsequent to the one recording medium is formed; and
a control unit configured to, based on the time interval between the detection signals generated according to the first and second light beams that are incident on the detection unit in the period in which the constant speed control is being executed by the speed control unit, control relative emission timings, for the plurality of light emitting elements, of light beams that are based on image data.

2. The image forming apparatus according to claim 1,
wherein in the period in which the constant speed control is being executed, the measuring unit controls the light source such that the first and second light beams from the first and second light emitting elements are sequentially incident on the detection unit so as to measure the time interval.

3. The image forming apparatus according to claim 1,
wherein the measuring unit measures the time interval in a period from when the speed control unit switches from the speed change control to the constant speed control, until when formation of an electrostatic latent image on the photosensitive member based on the image data is started.

4. The image forming apparatus according to claim 3, further comprising:
a storage unit configured to store in advance a reference value that is to be a reference for control performed by the control unit, and timing values indicating the emission timings for the plurality of light emitting elements, the timing values being set in association with the reference value,
wherein the control unit controls the emission timings for the plurality of light emitting elements using values obtained by correcting the timing values according to a difference between the time interval measured by the measuring unit and the reference value.

5. The image forming apparatus according to claim 1,
wherein the control unit:
in the period in which the rotation speed is the first rotation speed, controls the emission timings for the plurality of light emitting elements according to the time interval measured by the measuring unit; and
in the period in which the rotation speed is the second rotation speed, controls the emission timing for the plurality of light emitting elements based on the time interval measured by the measuring unit and a ratio between the first rotation speed and the second rotation speed.

6. The image forming apparatus according to claim 5, further comprising:
a storage unit configured to store in advance a reference value that is to be a reference for control performed by the control unit, and timing values indicating the emission timings, for the plurality of light emitting elements, the timing values being set in association with the reference value,
wherein the control unit:
in the period in which the rotation speed is the first rotation speed, controls the emission timings for the plurality of light emitting elements using a value obtained by correcting the timing values based on a difference between the time interval measured by the measuring unit and the reference value; and
in the period in which the rotation speed is the second rotation speed, controls the emission timings for the plurality of light emitting elements using a value obtained by correcting the timing values based on the ratio and the difference between the time interval measured by the measuring unit and the reference value.

7. The image forming apparatus according to claim 2,
wherein the measuring unit measures the time interval in a period from when formation of an electrostatic latent image on the photosensitive member based on the image data in the constant speed control is complete, until when the speed change control is started by the speed control unit.

8. The image forming apparatus according to claim 7,
wherein the control unit controls the emission timings for the plurality of light emitting elements, according to the time interval measured by the measuring unit, and a ratio between rotation speeds of the rotating polygonal mirror before starting and after completing the acceleration or deceleration of the rotation speed by means of the speed change control performed by the speed control unit.

9. The image forming apparatus according to claim 8, further comprising:
a storage unit configured to store in advance a reference value that is to be a reference for control performed by the control unit, and timing values indicating the emission timings for the plurality of light emitting elements, the timing values being set in association with the reference value,
wherein the control unit controls the emission timings for the plurality of light emitting elements using a value obtained by correcting the timing values based on the ratio and a difference between the time interval measured by the measuring unit and the reference value.

10. The image forming apparatus according to claim 1,
wherein the control unit controls the emission timings for the plurality of light emitting elements such that positions at which formation of electrostatic latent images is started coincide with each other between a plurality of main scanning lines scanned by the plurality of light beams.

11. The image forming apparatus according to claim 1,
wherein the plurality of light emitting elements are arranged in a linear array in the light source, and
the first and second light emitting elements are light emitting elements respectively arranged at two opposite ends among the plurality of light emitting elements.

12. The image forming apparatus according to claim 1, further comprising:
the photosensitive member;
a charging unit configured to charge the photosensitive member;
developing unit configured to develop an electrostatic latent image formed on the photosensitive member using toner;
a transfer unit configured to transfer the toner image developed on the photosensitive member onto a recording medium; and
a fixing unit configured to fix the toner image to the recording medium by heating the toner image that has been transferred onto the recording medium.

13. The image forming apparatus according to claim 12,
wherein the speed control unit controls the rotating polygonal mirror at the first rotation speed, in order to form an electrostatic latent image corresponding to a first toner image that is to be transferred onto a recording medium that has not been subjected to heating and fixing processing by the fixing unit, and
the speed control unit controls the rotating polygonal mirror at the second rotation speed, in order to form an electrostatic latent image corresponding to a second toner image that is to be transferred onto a second side that is a back side of a first side, which the first toner image has been formed on and has been subjected to the heating and fixing processing for the first toner image by the fixing unit, of the recording medium.

14. The image forming apparatus according to claim 12,
wherein the speed control unit controls the rotating polygonal mirror at the second rotation speed, in order to form an electrostatic latent image corresponding to a first toner image that is to be transferred onto a recording medium that has not been subjected to heating and fixing processing by the fixing unit, and
the speed control unit controls the rotating polygonal mirror at the first rotation speed, in order to form an electrostatic latent image corresponding to a second toner image that is to be transferred onto a second side that is a back side of a first side, which the first toner image has been formed on and has been subjected to the heating and fixing processing for the first toner image by the fixing unit, of the recording medium.

15. The image forming apparatus according to claim 1,
wherein the first rotation speed is a rotation speed of the rotating polygon mirror when forming an electrostatic latent image for forming a toner image that is to be transferred onto a first recording medium, and
the second rotation speed is a rotation speed of the rotating polygon mirror when forming an electrostatic latent image for forming a toner image that is to be transferred onto a second recording medium that is of a different type than the first recording medium.

16. The image forming apparatus according to claim 15,
wherein a grammage of the first recording medium is different from the grammage of the second recording medium.
